(19) United States
(12) Patent Application Publication
(10) Pub. No.: US 2023/0307645 A1
(43) Pub. Date: Sep. 28, 2023

(54) COMPOSITE PARTICLE, POSITIVE ELECTRODE, ALL-SOLID-STATE BATTERY, AND MANUFACTURING METHOD OF COMPOSITE PARTICLE

(71) Applicant: TOYOTA JIDOSHA KABUSHIKI KAISHA, Toyota-shi Aichi-ken (JP)

(72) Inventors: Masaru KUBOTA, Okazaki-shi Aichi-ken (JP); Shinji NAKANISHI, Toyota-shi Aichi-ken (JP)

(73) Assignee: TOYOTA JIDOSHA KABUSHIKI KAISHA, Toyota-shi Aichi-ken (JP)

(21) Appl. No.: 18/100,929

(22) Filed: Jan. 24, 2023

(30) Foreign Application Priority Data
Mar. 25, 2022 (JP) 2022-049686

(51) Int. Cl. H01M 4/62; H01M 10/0562

(52) U.S. Cl. CPC H01M 4/62; H01M 10/0562; H01M 2004/028

(57) ABSTRACT

The composite particle includes a positive electrode active material particle and a coating film. The coating film covers at least a part of a surface of the positive electrode active material particle. The coating film includes a phosphorus compound. The phosphorus compound includes at least one of Na and K and P.

### CROSS-REFERENCE TO RELATED APPLICATION

This application claims priority to Japanese Patent Application No. 2022-049686 filed on Mar. 25, 2022, incorporated herein by reference in its entirety.

### BACKGROUND

### 1. Technical Field

The present disclosure relates to a composite particle, a positive electrode, an all-solid-state battery, and a manufacturing method of a composite particle.

### 2. Description of Related Art

Japanese Unexamined Patent Application Publication No. 2010-135090 (JP 2010-135090 A) discloses forming a polyanion structure-containing compound at an interface between a positive electrode active material and a solid electrolyte.

### SUMMARY

Sulfide-based all-solid-state batteries (hereinafter, may be abbreviated as “all-solid-state batteries”) have been developed. The all-solid-state battery includes a sulfide solid electrolyte. When the sulfide solid electrolyte is in direct contact with a positive electrode active material particle, the sulfide solid electrolyte may deteriorate. Degradation of the sulfide solid electrolyte (ion conduction path) can increase battery resistance. Therefore, it has been proposed to form a coating film on a surface of the positive electrode active material particle. When the coating film inhibits direct contact between the positive electrode active material particle and the sulfide solid electrolyte, deterioration of the sulfide solid electrolyte can be reduced.

Conventionally, a phosphate compound is known as a raw material of a coating film. Coating treatment can be carried out, for example, in the following manner. That is, the phosphoric acid compound is dissolved in a solvent to prepare a coating liquid. The coating liquid adheres to a surface of the positive electrode active material particle. The coating liquid adhered to the particle surface is dried to form the coating film. It is believed that the coating film includes a phosphorus compound.

Conventionally, an impurity-free coating liquid has been used. This is because it is believed that impurities may adversely affect the properties of the coating film. For example, it is believed that impurities such as sodium (Na) and potassium (K) may inhibit the migration of lithium (Li) ions.

An object of the present disclosure is to reduce battery resistance.

A technical configuration and effects of the present disclosure will be described below. However, an effect mechanism of the present specification includes speculation. The effect mechanism does not limit the technical scope of the present disclosure.
1. A composite particle includes: a positive electrode active material particle; and a coating film. The coating film covers at least a part of a surface of the positive electrode active material particle. The coating film includes a phosphorus compound. The phosphorus compound includes at least one of sodium and potassium, and includes phosphorus.

In the present disclosure, Na and K are added to the coating film (phosphorus compound) contrary to the conventional idea. According to the novel finding of the present disclosure, rather, cell resistivity can be reduced by having the coating film include Na and K. In the coating liquid, the phosphoric acid compound may be converted into a low molecule substance by, for example, solvolysis or the like. For example, when Na and K increase the stability of the phosphate compound in the coating liquid, a high quality coating film may be formed and the cell resistivity may be reduced. At present, however, the details of the mechanism are unknown.
2. The composite particle described in the above “1.” may satisfy the relationship of the following equation (1).

C_{Na}/C_{P}≥0.01 (1)

In the above equation (1), C_{Na} and C_{P} represent an element concentration measured by X-ray photoelectron spectroscopy. C_{Na} represents an elemental concentration of sodium. C_{P} indicates an elemental concentration of phosphorus.

According to X-ray Photoelectron Spectroscopy (XPS), a surface composition of the composite particle can be determined. The surface composition of the composite particle corresponds to a composition of the coating film. In the above equation (1), “C_{Na}/C_{P}” represents a compositional fraction of a particle surface. When the above equation (1) is satisfied, a reduction in battery resistance is expected.
3. The composite particle described in the above “1.” or “2.” may have a coverage rate of, for example, 85% or more. The coverage rate is measured by X-ray photoelectron spectroscopy.

When the coating film contains Na and K, the coverage rate tends to be high. By improving the stability of the phosphoric acid compound in the coating liquid, the coating film having continuity is likely to be formed, and the coverage ratio may be improved. As a result of the improvement in the coverage ratio, there is a possibility that a contact opportunity between the sulfide solid electrolyte and the positive electrode active material particles is reduced and that the battery resistance is reduced.
4. A positive electrode includes: the composite particle according to any one of the above “1.” to “3.”; and a sulfide solid electrolyte.
5. An all-solid-state battery includes the positive electrode according to the above “4.”
6. A manufacturing method of a composite particle includes: (a) preparing a mixture by mixing the coating liquid and a positive electrode active material particle; and (b) manufacturing the composite particle by drying the mixture.
   The coating liquid includes a solute and a solvent. The solute includes at least one of sodium and potassium, and includes phosphorus.
   The coating liquid satisfies a relationship of the following equation (2).

n_{Na}/n_{P}≥0.02 (2)

In the above equation (2), n_{P} represents a molar concentration of phosphorus in the coating liquid. n_{Na} represents a molarity of sodium in the coating liquid.

When the coating liquid satisfies the relationship of the above equation (2), the composite particle described in the above “1.” may be formed.
7. In the manufacturing method described in the above “6.”, a weight fraction of sodium in the coating liquid may be, for example, 1.46×10⁴ ppm or more.
8. In the manufacturing method described in the above “6.” or “7.”, the solute may include at least one selected from a group consisting of metaphosphoric acid and polyphosphoric acid.

Metaphosphoric acid and polyphosphoric acid are phosphate compounds. Metaphosphoric acid and polyphosphoric acid may have longer molecular chains than other phosphate compounds. When the solute contains at least one of metaphosphoric acid and polyphosphoric acid, for example, it is expected that a coating film having continuity is easily formed. As a result, for example, an improvement in the coverage rate is expected.

Hereinafter, embodiments of the present disclosure (hereinafter can be abbreviated as the “present embodiment”) and examples of the present disclosure (hereinafter can be abbreviated as the “present example”) will be described. However, the present embodiment and the present example do not limit the technical scope of the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing composite particles in this embodiment;

FIG. 2 is a conceptual diagram showing an all-solid-state battery according to the present embodiment;

FIG. 3 is a schematic flowchart of a manufacturing method of composite particles according to the present embodiment.

### DETAILED DESCRIPTION OF EMBODIMENTS

### Definitions of Terms

Statements of “comprising,” “including,” and “having,” and variations thereof (for example “composed of”) are open-ended format. The open-ended format may or may not include an additional element in addition to a required element. A statement of “consisting of” is a closed format. However, even when the statement is the closed format, normally associated impurities and additional elements irrelevant to the disclosed technique are not excluded. A statement “substantially consisting of” is a semi-closed format. The semi-closed format allows addition of an element that does not substantially affect the basic and novel characteristics of the disclosed technique.

“At least one of A and B” includes “A or B” and “A and B”. “At least one of A and B” may also be referred to as “A and/or B.”

Expressions such as “may” and “can” are used in the permissive sense of “having the possibility of” rather than in the obligatory sense of “must”.

Elements expressed in the singular also include the plural unless specifically stated otherwise. For example, “particle” may mean not only “one particle” but also “an aggregate of particles (powder, powder, particle group)”.

For multiple steps, actions, operations, and the like included in various methods, the execution order thereof is not limited to the described order unless otherwise specified. For example, the multiple steps may proceed concurrently. For example, the multiple steps may occur one after the other.

For example, numerical ranges such as “m % to n %” include upper and lower limit values unless otherwise specified. That is, “m % to n %” indicates a numerical range of “m % or more and n % or less”. In addition, “m % or more and n % or less” includes “more than m % and less than n %”. Further, a numerical value selected as appropriate from within the numerical range may be used as a new upper limit value or a new lower limit value. For example, a new numerical range may be set by appropriately combining numerical values within the numerical range with numerical values described in other parts of the present specification, tables, drawings, and the like.

All numerical values are modified by the term “approximately.” The term “approximately” can mean, for example, ±5%, ±3%, ±1%, and the like. All numerical values can be approximations that may vary depending on the mode of use of the disclosed technique. All numerical values can be displayed with significant digits. A measured value can be an average value of multiple measurements. The number of measurements may be three or more, five or more, or ten or more. In general, it is expected that the reliability of the average value improves as the number of measurements increases. The measured value can be rounded by rounding based on the number of significant digits. The measured value can include errors and the like associated with, for example, the detection limit of a measuring device.

Geometric terms (for example, “parallel”, “perpendicular”, and “orthogonal”) are not to be taken in a strict sense. For example, “parallel” may deviate somewhat from “parallel” in a strict sense. Geometric terms may include, for example, design, work, manufacturing tolerances, errors, etc. Dimensional relationships in each drawing may not match actual dimensional relationships. The dimensional relationships (length, width, thickness, etc.) in each drawing may be changed to facilitate understanding of the disclosed technique. Further, a part of the configuration may be omitted.

When a compound is represented by a stoichiometric compositional equation (e.g., “LiCoO₂”), the stoichiometric compositional formula is only representative of the compound. The compound may have a non-stoichiometric composition. For example, when lithium cobaltate is expressed as “LiCoO₂”, unless otherwise specified, lithium cobaltate is not limited to a composition ratio of “Li/Co/O=1/1/2”, and may include Li, Co, and O at any composition ratio. In addition, doping, substitution, and the like with trace elements can also be tolerated.

“D50” indicates a particle diameter in which the cumulative frequency from the side having the smaller particle diameter reaches 50% in the volume-based particle diameter distribution. D50 can be measured by laser diffraction.

### <XPS Measurement>

### (Composition Ratio at Particle Surface)

The composition-ratio “C_{Na}/C_{P}” and “C_{K}/C_{P}” at the particle-surface may be measured in the following manner. An XPS device is prepared. For example, the XPS device “Product-Name PHIX-tool” (or equivalent) manufactured by ULVAC FIE may be used. A sample powder consisting of composite particles is set in an XPS apparatus. With a pass energy of 224 eV, a narrow scan analysis is performed. The measurement data is processed by the analysis software. For example, an analysis software “MulTiPak” (or equivalent) manufactured by ULVAC FIRE may be used. The peak area of P2p spectrum is converted to the elemental density of P (C_{P}). The peak area of Na1s spectrum is converted to the elemental density of Na (C_{Na}). The peak area of K2p_{3/2} spectrum is converted to an elemental density of K (C_{K}). By dividing C_{Na} by C_{P}, the compositional ratio “C_{Na}/C_{P}” is obtained. By dividing C_{K} by C_{P}, the compositional ratio “C_{K}/C_{P}” is obtained.

### (Coverage)

Coverage is also measured by XPS. C1s, O1s, P2p, Na1s, K2p_{3/2}, M2p (or M2p_{3/2}) and the like are used to calculate the ratio (element density) of each element. The coverage ratio is determined by the following equation (3).

θ=(P+Na+K)/(P+Na+K+M)×100 (3)

In the above equation (3), θ represents a coverage ratio (%). P, Na, K, M represents the ratio of the respective elements.

“M2p (or M2p_{3/2})” and M in the above equation (3) are constituent elements of the positive electrode active material particles, and represent elements other than Li and O. That is, the positive electrode active material particles may be represented by the following equation (4).

LiMO₂ (4)

M may be composed of one element or a plurality of elements. M may be, for example, at least one selected from the group consisting of nickel (Ni), cobalt (Co), manganese (Mn), and aluminum (Al). When M includes a plurality of elements, the total composition ratio of each element may be 1.

For example, when the positive electrode active material particles are “LiNi_{1/3}Co_{1/3}Mn_{1/3}O₂”, the above equation (3) can be transformed into the following equation (3′).

θ=(P+Na+K)/(P+Na+K+Ni+Co+Mn)×100 (3′)

Ni in the above equation (3′) represents the elemental ratio of nickel determined from the peak area of Ni2p_{3/2}. Co represents the elemental proportion of cobalt determined from the peak area of Co2p_{3/2}. Mn represents the elemental proportion of manganese determined from the peak area of Mn2p_{3/2}.

### <Film Thickness Measurement>

The film thickness (thickness of the coating film) can be measured by the following procedure. The sample is prepared by embedding the composite particles in a resin material. The sample is subjected to a cross-section forming process by an ion milling apparatus. For example, an ion milling device “Arblade 5000” (or equivalent) manufactured by Hitachi High-Technologies may be used. The cross-section of the sample is observed by Scanning Electron Microscope (SEM). For example, an SEM-device “product-name SU8030” (or equivalent) manufactured by Hitachi High-Technologies may be used. For each of the ten composite particles, the film thickness is measured in 20 fields of view. The arithmetic average of the film thicknesses at a total of 200 positions is regarded as the film thickness.

### <ICP Measurement>

The molar ratio “n_{Na}/n_{P}” and “n_{K}/n_{P}” in the coating liquid are measured in the following manner. By diluting 0.01 g of the coating liquid with pure water, 100 ml of the sample liquid is prepared. An aqueous solution (1000 ppm, 10000 ppm) of P, Na, K is prepared. A standard solution is prepared by diluting 0.01 g of the aqueous solution with pure water. Inductively Coupled Plasma Atomic Emission Spectroscopy (ICP-AES) A device is prepared. The emission intensity of the reference solution is measured by ICP-AES device. A calibration curve is prepared from the emission intensity of the standard solution. ICP-AES device measures the emission intensity of the sample liquid (diluent of the coating liquid). From the emission intensity of the sample solution and the calibration curve, the mass-concentration of P, Na, and K in the coating liquid is determined. In addition, the masses of P, Na, K are converted to molar concentrations. By dividing the molar concentration of Na (n_{Na}) by the molar concentration of P (n_{P}), the molar ratio “n_{Na}/n_{P}” is obtained. By dividing the molar concentration of K (n_{K}) by the molar concentration of P (n_{P}), the molar ratio “n_{K}/n_{P}” is obtained.

### <Composite Particles>

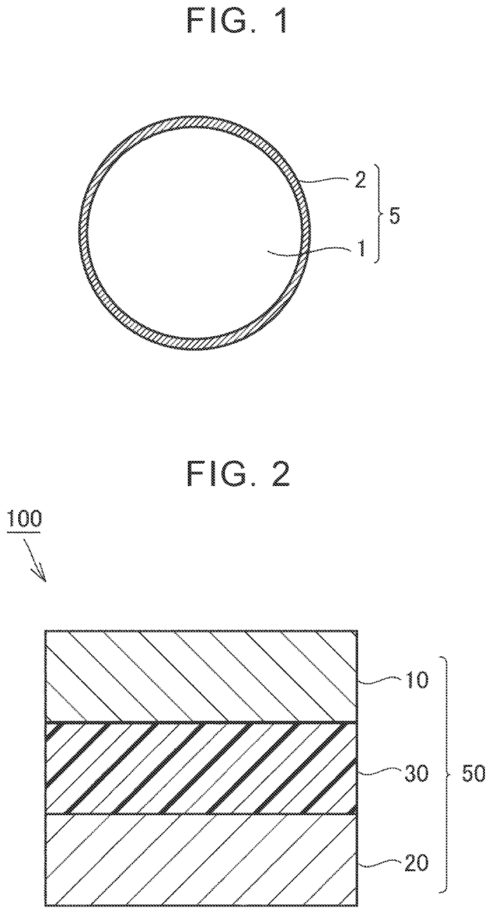

FIG. 1 is a conceptual diagram showing composite particles in the present embodiment. The composite particles 5 may be referred to as “coated positive electrode active material” or the like, for example. The composite particles 5 include positive electrode active material particles 1 and a coating film 2. The composite particles 5 may form, for example, aggregates. That is, one composite particle 5 may contain two or more positive electrode active material particles 1. The composite particles 5 may have, for example, a D50 of 1 to 50 μm, a D50 of 1 to 20 μm, or a D50 of 5 to 15 μm.

### <Coating Film>

The coating film 2 is a shell of composite particles 5. The coating film 2 covers at least a part of the surface of the positive electrode active material particles 1. The coating film 2 contains a phosphorus compound. The phosphorus compound includes at least one of Na and K and P.

For example, the phosphorus compound may include at least one selected from the group consisting of Na, K, rubidium (Rb), cesium (Cs), Fr (francium), beryllium (Be), magnesium (Mg), calcium (Ca), strontium (Sr), barium (Ba), and radium (Ra), and P.

The phosphorus compound may further include, for example, lithium (Li), oxygen (O), carbon (C), and the like. P may have, for example, a mass fraction of 1 to 10% with respect to the composite particles 5. The composite particles may satisfy, for example, the relationship of the following equation (5).

C_{Li}/C_{P}≤2.5 (5)

In the above equation (5), Cu represents the element level of Li. C_{P} indicates the elemental concentration of P. C_{Li}, C_{P} is measured by XPS. The peak area of Li1s spectrum is converted to C_{Li}. “C_{Li}/C_{P}” indicates the compositional fraction of Li to P at the grain surface. When the relationship of the above equation (5) is satisfied, for example, a reduction in battery resistance is expected.

The phosphorus compound may include, for example, a phosphate skeleton. That is, the phosphorus compound may be a phosphoric acid compound. When the phosphorus compound comprises a phosphate backbone, e.g. by Time-of-Flight Secondary Ion Mass Spectrometry (TOF-SIMS), a fragment such as PO₂⁻, PO₃⁻ can be detected when analyzing the composite particles 5.

The compositional ratio “C_{Na}/C_{P}” on the grain surface may be, for example, 0.01 or more. When the composition-ratio “C_{Na}/C_{P}” is 0.01 or more, a reduction in the cell resistivity is expected. The compositional ratio “C_{Na}/C_{P}” may be, for example, 0.11 or more, or 0.49 or more. The compositional ratio “C_{Na}/C_{P}” may be, for example, 0.49 or less, or 0.11 or less.

The compositional ratio “(C_{Na}+C_{K})/C_{P}” at the grain surface may be, for example, 0.01 or more. The compositional ratio “(C_{Na}+C_{K})/C_{P}” may be, for example, 0.11 or more, or 0.49 or more. The compositional ratio “(C_{Na}+C_{K})/C_{P}” may be, for example, 0.49 or less, or 0.11 or less.

The coverage may be, for example, 85% or more. When the coverage is 85% or more, a reduction in battery resistance is expected. The coverage may be, for example, 88% or more, or 89% or more. The coverage may be, for example, 100% or less, 95% or less, or 89% or less.

The coating film 2 may have, for example, a thickness of 5 to 100 nm, a thickness of 5 to 50 nm, a thickness of 10˜30 nm, or a thickness of 20˜30 nm.

### <Positive Electrode Active Material Particles>

The positive electrode active material particles 1 are cores of the composite particles 5. The positive electrode active material particles 1 may be secondary particles (aggregates of primary particles). The positive electrode active material particles 1 (secondary particles) may have, for example, a D50 of 1 to 50 μm, a D50 of 1 to 20 μm, or a D50 of 5 to 15 μm. The primary particles may have a maximum Feret diameter of, for example, 0.1-3 μm.

The positive electrode active material particles 1 may include an optional component. The positive electrode active material particles 1 may include, for example, at least one selected from the group consisting of LiCoO₂, LiNiO₂, LiMnO₂, LiMn₂O₄, Li(NiCoMn)O₂, Li(NiCoAl)O₂, and LiFePO₄. For example, “(NiCoMn)” in “Li(NiCoMn)O₂” indicates that the sum of the compositional ratios in parentheses is 1. As long as the sum is 1, the amounts of the individual components are optional. Li(NiCoMn)O₂ may include, for example, LiNi_{1/3}Co_{1/3}Mn_{1/3}O₂, LiNi_{0.5}Co_{0.2}Mn_{0.3}O₂, LiNi_{0.8}Co_{0.1}Mn_{0.1}O₂. Li(NiCoAl)O₂ may include, for example, LiNi_{0.80}Co_{0.15}Al_{0.05}O₂.

### <All-Solid-State Battery>

FIG. 2 is a conceptual diagram illustrating an all-solid-state battery according to the present embodiment. The all-solid-state battery includes a power generating element 50. The all-solid-state battery 100 may include, for example, an exterior body (not shown). The exterior body may be, for example, a pouch made of a metal foil laminate film or the like. The exterior body may house the power generating element 50. The power generation element 50 includes a positive electrode 10, a separator layer 30, and a negative electrode 20. That is, the all-solid-state battery 100 includes the positive electrode 10, the separator layer 30, and the negative electrode 20.

### <Positive Electrode>

The positive electrode 10 is layered. For example, the positive electrode 10 may include a positive electrode active material layer and a positive electrode current collector. For example, a positive electrode active material layer may be formed by coating a positive electrode mixture on the surface of a positive electrode current collector. The positive electrode current collector may include, for example, an Al foil. The positive electrode current collector may have a thickness of, for example, 5 to 50 μm.

The positive electrode active material layer may have a thickness of, for example, 10 to 200 μm. The positive electrode active material layer is in close contact with the separator layer 30. The positive electrode active material layer includes a positive electrode mixture. The positive electrode mixture includes composite particles and a sulfide solid electrolyte. That is, the positive electrode 10 includes composite particles and a sulfide solid electrolyte. Details of the composite particles are as described above.

The sulfide solid electrolyte may form an ion conduction path in the positive electrode active material layer. The blending amount of the sulfide solid electrolyte may be, for example, 1 to 200 parts by volume, 50 to 150 parts by volume, or 50 to 100 parts by volume with respect to 100 parts by volume of the composite particles (positive electrode active material). The sulfide solid electrolyte includes sulfur (S). The sulfide solid electrolyte may include, for example, Li, P, and S. The sulfide solid electrolyte may further contain, for example, oxygen (O), silicon (Si), or the like. The sulfide solid electrolyte may further contain, for example, a halogen. The sulfide solid electrolyte may further contain, for example, iodine (I), bromine (Br), and the like. The sulfide solid electrolyte may be, for example, a glass-ceramic type or an argyrodite type. Sulfide solid electrolyte, for example, LiI—LiBr—Li₃PS₄, Li₂S—SiS₂, LiI—Li₂S—SiS₂, LiI—Li₂S—P₂S₅, LiI—Li₂O—Li₂S—P₂S₅, LiI—Li₂S—P₂O₅, LiI—Li₃PO₄—P₂S₅, Li₂S—P₂S₅, at least one selected from the group consisting of Li₃PS₄.

For example, “LiI—LiBr—Li₃PS₄” refers to a sulfide solid electrolyte produced by mixing LiI and LiBr with Li₃PS₄ in any molar ratio. For example, a sulfide solid electrolyte may be produced by a mechanochemical process. “Li₂S—P₂S₅” includes Li₃PS₄. Li₃PS₄ may be generated, for example, by mixing Li₂S and P₂S₅ with “Li₂S/P₂S₅=75/25”.

The positive electrode active material layer may further include, for example, a conductive material. The conductive material may form an electron conduction path in the positive electrode active material layer. The blending amount of the conductive material may be, for example, 0.1 to 10 parts by mass with respect to 100 parts by mass of the composite particles (positive electrode active material). The conductive material may include any component. The conductive material may include, for example, at least one selected from the group consisting of carbon black, vapor-grown carbon fibers (VGCF), carbon nanotubes (CNTs), and graphene flakes.

The positive electrode active material layer may further include, for example, a binder. The amount of the binder may be, for example, 0.1 to 10 parts by mass with respect to 100 parts by mass of the composite particles (positive electrode active material). The binder may comprise any component. The binder may include, for example, at least one selected from the group consisting of polyvinylidene fluoride (PVdF), vinylidene fluoride-hexafluoropropylene copolymer (PVdF-HFP), styrene-butadiene rubber (SBR), and polytetrafluoroethylene (PTFE).

### <Negative Electrode>

The negative electrode 20 is layered. For example, the negative electrode 20 may include a negative electrode active material layer and a negative electrode current collector. For example, the negative electrode active material layer may be formed by coating a negative electrode mixture on the surface of the negative electrode current collector. The negative electrode current collector may include, for example, a Cu foil, a Ni foil, or the like. The negative electrode current collector may have a thickness of, for example, 5 to 50 μm.

The negative electrode active material layer may have a thickness of, for example, 10 to 200 μm. The negative electrode active material layer is in close contact with the separator layer 30. The negative electrode active material layer includes a negative electrode mixture. The negative electrode mixture includes negative electrode active material particles and a sulfide solid electrolyte. The negative electrode mixture may further include a conductive material and a binder. Between the negative electrode mixture and the positive electrode mixture, the sulfide solid electrolyte may be of the same type or different types. The negative electrode active material particles may include an optional component. The negative electrode active material particles may include, for example, at least one selected from the group consisting of graphite, Si, SiOₓ (0<x<2), and Li₄Ti₅O₁₂.

### <Separator Layer>

The separator layer 30 is interposed between the positive electrode 10 and the negative electrode 20. The separator layer 30 separates the positive electrode 10 from the negative electrode 20. The separator layer 30 includes a sulfide solid electrolyte. The separator layer 30 may further include a binder. Between the separator layer 30 and the positive electrode mixture, the sulfide solid electrolyte may be of the same type or may be of different types. Between the separator layer 30 and the negative electrode mixture, the sulfide solid electrolyte may be of the same type or may be of different types.

### <Manufacturing Method of Composite Particles>

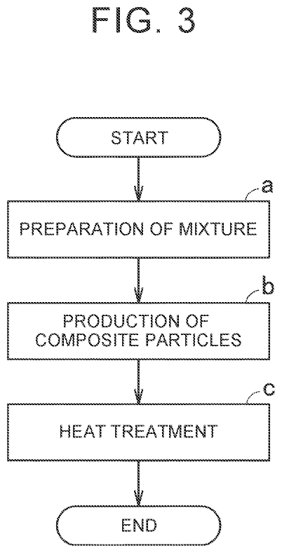

FIG. 3 is a schematic flowchart of a manufacturing method of composite particles according to the present embodiment. Hereinafter, the “manufacturing method of composite particles in the present embodiment” may be abbreviated as “the present production method”. The manufacturing method comprises “(a) preparation of the mixture” and “(b) preparation of the composite particles”. The manufacturing method may further include, for example, “(c) heat treatment”.

### (a) Preparation of Mixtures

The manufacturing method includes preparing a mixture by mixing a coating liquid and positive electrode active material particles. The details of the positive electrode active material particles are as described above. The mixture may be, for example, a suspension or a wet flour. For example, a suspension may be formed by dispersing positive electrode active material particles (powder) in a coating liquid. For example, a wet powder may be formed by spraying a coating liquid into the powder. Any mixing device, granulation device, or the like may be used in the present manufacturing method.

The coating liquid includes a solute and a solvent. The solute includes the raw material of the coating film. The coating liquid may further include, for example, a suspension (insoluble component), a precipitate, and the like.

The solute amount may be, for example, 0.1 to 20 parts by mass, 1 to 15 parts by mass, or 5 to 10 parts by mass with respect to 100 parts by mass of the solvent. The solvent may comprise any component so long as the solute dissolves. The solvent may include, for example, water, alcohol, and the like. The solvent may include, for example, ion-exchanged water.

The solute includes at least one of Na and K and P. The solute may comprise, for example, a phosphate of Na, K, etc. The solute may include, for example, sodium orthophosphate, potassium orthophosphate, disodium hydrogen phosphate, dipotassium hydrogen phosphate, and the like.

The solute may comprise, for example, a phosphate compound. The solute may comprise, for example, at least one selected from the group consisting of phosphate anhydride (P₂O₅), orthophosphate, pyrophosphate, metaphosphate [(HPO₃)ₙ], and polyphosphate. The solute may comprise, for example, at least one selected from the group consisting of metaphosphoric acid and polyphosphoric acid. Metaphosphoric acid and polyphosphoric acid may have longer molecular chains than other phosphate compounds. It is considered that the phosphoric acid compound has a long molecular chain, and thus a coating film having continuity is likely to be formed. When the coating film has continuity, for example, an improvement in coverage is expected.

When the solute contains Na, the molar ratio of Na to P “n_{Na}/n_{P}” is greater than or equal to 0.02. The molar ratio “n_{Na}/n_{P}” may be, for example, 0.12 or more, or 0.50 or more, or 0.75 or more. The molar ratio “n_{Na}/n_{P}” may be, for example, 1 or less, or 0.75 or less.

If the solute comprises K, the molar ratio of K to P, where “n_{K}/n_{P}”, is, for example, greater than or equal to 2.22×10⁻⁵. The molar ratio “n_{K}/n_{P}” may be, for example, 3.80×10⁻⁵ or more, or 9.51×10⁻⁵ or more. The molar ratio “n_{K}/n_{P}” may be, for example, 8.00×10⁻³ or less, or 9.51×10⁻⁵ or less.

The concentration (mass fraction) of Na in the coating liquid may be, for example, 1.46×10⁴ ppm (1.46%) or more. This is expected to reduce the battery resistance. The density of Na may be, for example, 8.18×10⁴ ppm or more, 2.71×10⁵ ppm or more, or 3.58×10⁵ ppm or more. The density of Na may be, for example, 4.30×10⁵ ppm (43%) or less, or 3.58×10⁵ ppm or less.

The concentration (mass fraction) of K in the coating liquid may be, for example, 28 ppm or more. This is expected to reduce the battery resistance. The density of K may be, for example, 48 ppm or higher, or 120 ppm or higher. The density of K may be, for example, less than or equal to 10000 ppm or less than or equal to 120 ppm.

The solute may further comprise, for example, a lithium compound. The solute may include, for example, lithium hydroxide, lithium carbonate, lithium nitrate, and the like.

The molar ratio of Li to P “n_{Li}/n_{P}” may be, for example, less than 1.1. When the molar ratio “n_{Li}/n_{P}” is less than 1.1, for example, a reduction in cell resistivity is expected. The molar ratio “n_{Li}/n_{P}” may be, for example, 1.07 or less, or 0.45 or less, or may be 0. The molar ratio “n_{Li}/n_{P}” may be, for example, 0 to 0.45 or 0.45 to 1.07.

### (b) Production of Composite Particles

The manufacturing method includes producing composite particles by drying the mixture. The coating liquid adhering to the surface of the positive electrode active material particle is dried to form the coating film. Any drying method may be used in the present manufacturing method.

For example, the composite particles may be formed by a spray drying method. That is, the liquid droplets are formed by spraying the suspension from the nozzle. The droplets include positive electrode active material particles and a coating liquid. For example, the droplets may be dried by hot air to form composite particles. The use of a spray-drying process is expected to improve the coverage, for example.

The solids fraction of the suspension for spray drying may be, for example, 1-50% or 10-30% by volume. The nozzle diameter may be, for example, 0.1 to 10 mm or 0.1 to 1 mm. The hot air temperature may be, for example, 100 to 200° C.

For example, composite particles may be produced by a rolling fluidized bed coating apparatus. In a rolling fluidized bed coating apparatus, “(a) preparation of a mixture” and “(b) production of composite particles” can be performed simultaneously.

### (c) Heat Treatment

The manufacturing method may include subjecting the composite particles to a heat treatment. The coating film may be fixed by heat treatment. The heat treatment may also be referred to as “calcination”. Any heat treatment apparatus may be used in the present manufacturing method. The heat treatment temperature may be, for example, 150 to 300° C. The heat treatment time may be, for example, 1 to 10 hours. For example, the heat treatment may be performed in air, or may be performed in an inert atmosphere.

### Experiment 1

In Experiment 1, the effect of Na was investigated. The composite particle, positive electrode and all-solid-state batteries according to No. 14 were produced as follows. Hereinafter, for example, the term “No. 1 composite particle” may be abbreviated as “No. 1”.

### (No. 1)

Metaphosphoric acid (manufactured by Fujifilm Wako Pure Chemical Co., Ltd.) was prepared as a phosphate compound. The reagent contained sodium phosphate as an excipient. A phosphoric acid solution was prepared by dissolving 10.8 parts by mass of metaphosphoric acid in 166 parts by mass of ion-exchanged water.

Electrodialysis equipment (product name “Asilizer EX3B”, manufactured by Astom Co.) was prepared. The phosphoric acid solution was subjected to desalting treatment by an electrodialyzer. The operating conditions of the equipment are as follows.

Electrodialysis tank: 2-chamber electrodialysis tank (bipolar membrane+cation exchange membrane)
Alkaline solution, electrode solution: aqueous sodium hydroxide solution (0.5 mol/L)
Rated capacity: 4.4 A
Processing time (operating time): 90 minutes

After the desalting treatment, the lithium hydroxide monohydrate was dissolved in the phosphoric acid solution so that the molar ratio “n_{Li}/n_{P}” was 0.45, thereby producing a coating liquid. The molar ratio “n_{Na}/n_{P}” and Na concentration were measured according to the above-described procedure. The measurement results are shown in Table 1 below. In Table 1, for example, “E+02” indicates “×10²”.

Li(Ni_{1/3}Co_{1/3}Mn_{1/3})O₂ was prepared as the positive electrode active material particle. A suspension was prepared by dispersing 50 parts by mass of the powder of the positive electrode active material particles in 53.7 parts by mass of the coating liquid. A spray dryer “MiniSprayDryerB-290” from BUCHI was prepared. The suspension was fed to a spray dryer to produce a powder of composite particles. The supply air temperature of the spray dryer was 200° C., and the supply air volume was 0.45 m³/min. The composite particles were heat treated in air. The heat treatment temperature was 200° C. The heat treatment time was 5 hours. According to the above-described procedure, the composition-ratio “C_{Na}/C_{P}” of the particle-surface and the coverage ratio were measured. The measurement results are shown in Table 1 below.

The following materials were prepared.
Sulfide solid electrolyte: 10LiI-15LiBr-75Li₃PS₄
Conductive material: VGCF
Binder: SBR
Dispersion medium: Heptane
Positive electrode current collector: Al foil

A positive electrode slurry was prepared by mixing composite particles, a sulfide solid electrolyte, a conductive material, a binder, and a dispersion medium. The mixing ratio of the composite particle and the sulfide solid electrolyte was “composite particle/sulfide solid electrolyte=6/4 (volume ratio)”. The blending amount of the conductive material was 3 parts by mass with respect to 100 parts by mass of the composite particles. The amount of the binder was 3 parts by mass with respect to 100 parts by mass of the composite particles. The positive electrode slurry was sufficiently stirred by the ultrasonic homogenizer. A coating film was formed by coating the positive electrode slurry on the surface of the positive electrode current collector. The coating was dried by hot plate at 100° C. for 30 minutes. As a result, a positive electrode original fabric was produced. A disk-shaped positive electrode was cut out from the positive electrode original material. The area of the positive electrode was 1 cm².

A negative electrode and a separator layer were prepared. The negative electrode active material particles were graphite. The same kind of sulfide solid electrolyte was used between the positive electrode, the separator layer and the negative electrode. In the cylindrical jig, the positive electrode, the separator layer, and the negative electrode were laminated to form a laminated body. By pressing the laminate, a power generation element was formed. An all-solid-state battery was formed by connecting a terminal to a power generation element.

### (No. 2)

Coating liquids, composite particles, positive electrodes and all-solid-state batteries were produced as in No. 1, except that the treatment duration of the desalting treatment was changed to 60 minutes.

### (No. 3)

Coating liquids, composite particles, positive electrodes and all-solid-state batteries were produced as in No. 1, except that the treatment duration of the desalting treatment was changed to 30 minutes.

### (No. 4)

Coating liquids, composite particles, positive electrodes and all-solid-state batteries were produced as in No. 1, except that no desalting treatment was performed.

### <Evaluation>

Battery resistance was measured. The measurement results are shown in Table 1 below. The battery resistance in Table 1 below is a relative value. In Experiment 1, No. 1 cell resistivity is defined as 100.

TABLE 1

| | | | | Composite particle | | |
|---|---|---|---|---|---|---|
| | Manufacturing method | | | Coating film | | |
| | Coating liquid | | | XPS | | |
| | | ICP | | | Composition | |
| | | Molar ratio | Na level | Coverage | ratio | Battery |
| | Phosphorylated | n_{Na}/nₚ | (mass fraction) | rate | C_{Na}/Cₚ | resistance |
| No. | compound | [—] | [ppm] | [%] | [—] | [—] |
| 1 | Metaphosphoric | 0.001 | 7.42E+02 | 80 | 0.00 | 100 |
| | acid | | | | | |
| 2 | Metaphosphoric | 0.02 | 1.46E+04 | 85 | 0.01 | 25 |
| | acid | | | | | |
| 3 | Metaphosphoric | 0.12 | 8.18E+04 | 88 | 0.11 | 18 |
| | acid | | | | | |
| 4 | Metaphosphoric | 0.50 | 2.71E+05 | 88 | 0.49 | 7 |
| | acid | | | | | |

### <Results>

As shown in Tables 1 above, cell resistivity is reduced in No. 2 to 4 compared to No. 1. In No. 1, the composition-ratio “C_{Na}/C_{P}” is zero. The coating film of No. 1 is believed to be free of Na. In No. 2 to 4, the composition-ratio “C_{Na}/C_{P}” is greater than zero. The coating films of No. 2 4 are believed to comprise Na. No. 2-4 tend to have higher coverage than No. 1.

The present embodiment and the present example are illustrative in all respects. The present embodiment and the present example are not restrictive. The technical scope of the present disclosure includes all changes within the meaning and range equivalent to the description of the claims. For example, from the beginning, it is planned to extract an appropriate configuration from the present embodiment and the present example and combine them as appropriate.

What is claimed is:

1. A composite particle comprising:
a positive electrode active material particle; and
a coating film,
wherein the coating film covers at least a part of a surface of the positive electrode active material particle,
wherein the coating film includes a phosphorus compound, and
wherein the phosphorus compound includes at least one of sodium and potassium, and includes phosphorus.

2. The composite particle according to claim 1, wherein:
a relationship of the following equation (1) is satisfied:
C_{Na}/C_{P}≥0.01 (1); and
in the above equation (1), C_{Na} and C_{P} represent an element concentration measured by X-ray photoelectron spectroscopy, C_{Na} represents an element concentration of sodium, and C_{P} represents an element concentration of phosphorus.

3. The composite particle according to claim 1, wherein:
a coverage rate is 85% or more; and
the coverage rate is measured by X-ray photoelectron spectroscopy.

4. A positive electrode comprising:
the composite particle according to claim 1; and
a sulfide solid electrolyte.

5. An all-solid-state battery comprising the positive electrode according to claim 4.

6. A manufacturing method of a composite particle, the manufacturing method comprising:
(a) preparing a mixture by mixing a coating liquid and a positive electrode active material particle; and
(b) manufacturing the composite particle by drying the mixture,
wherein the coating liquid includes a solute and a solvent,
wherein the solute includes at least one of sodium and potassium, and includes phosphorus, and
wherein the coating liquid satisfies a relationship of the following equation (2):
n_{Na}/n_{P}≥0.02 (2),
and in the above equation (2), n_{P} represents a molar concentration of phosphorus in the coating liquid, and n_{Na} represents a molar concentration of sodium in the coating liquid.

7. The manufacturing method according to claim 6, wherein a weight fraction of sodium in the coating liquid is 1.46×10⁴ ppm or more.

8. The manufacturing method according to claim 6, wherein the solute includes at least one selected from a group consisting of metaphosphoric acid and polyphosphoric acid.
